(19) United States
(12) Patent Application Publication
(10) Pub. No.: US 2008/0188993 A1
(43) Pub. Date: Aug. 7, 2008

(54) Power source management apparatus

(75) Inventor: Takeshi Ikusawa, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/798,480

(22) Filed: May 14, 2007

(30) Foreign Application Priority Data
Feb. 7, 2007 (JP) 2007-027737

(51) Int. Cl. G05B 11/00

(52) U.S. Cl. 700/297

(57) ABSTRACT

Disclosed is a power source management apparatus including: a receiving section to receive information about a consumed electric power value in a predetermined area; a transmitting section to transmit a control instruction to an image forming apparatus; and a control section to allow the transmitting section to transmit an instruction to the image forming apparatus to switch to a low-power mode with less electric power consumption than a normal electric power mode or a power-off mode, when the electric power value is a predetermined standard switching value or higher.

### CROSS-REFERENCE TO RELATED APPLICATIONS

The present U.S. patent application claims a priority under the Paris Convention of Japanese Patent Application No. 2007-027737 filed on Feb. 7, 2007 to the Japanese Patent Office, which shall be a basis for correcting mistranslations.

### BACKGROUND

1. Field of the Invention

The present invention relates to a power source management apparatus to manage electric power consumption of an image forming apparatus.

2. Description of Related Art

Conventionally, image forming apparatuses such as, copiers, printers, etc.; personal computers; and the like switch to a low-power mode where the electric power consumption is smaller than a normal electric power mode or a power-off mode to save electric power, when the apparatuses are not used for a predetermined span of time or when given instructions by the user. Alternatively, image forming apparatuses have been developed, wherein by setting the apparatuses so that it will switch to the low-power mode or the power-off mode at a predetermined time frame, for example, everyday 5:00 PM or later, every Friday 10:00 PM or later, etc., the apparatuses can switch to the low-power mode or the power-off mode automatically late at night or on weekends.

During a heat period of summer, electric power consumption drastically increases throughout the entire society due to the use of air conditioners etc., which may cause shortage of electric power. Thus, image forming apparatuses that switch to an energy-conservation mode at a predetermined time frame (for example, from 1:00 PM to 3:00 PM) for a predetermined period (for example, from July to August) have been proposed (See Japanese Patent Application Laid-Open Publication No. 2002-55569).

However, when the image forming apparatus is set to switch to the low-power mode or the power-off mode at a predetermined time frame, the apparatus switches to the low-power mode or the power-off mode regardless of the weather, thus there are cases where electric power shortage do not actually occur. As a result, there has been a problem that if the image forming apparatus is switched to the low-power mode or the power-off mode even when it is not necessary, the user could not readily use the apparatus when he wants to.

### SUMMARY

The present invention has been made in consideration of the above problem of the conventional techniques, and it is one of main objects to reduce electric power consumption of an image forming apparatus to prevent or aid to prevent electric power shortage.

To achieve at least one of the above mentioned objects, a power source management apparatus reflecting one aspect of the present invention comprises:

a receiving section to receive information about consumed electric power value in a predetermined area;

a transmitting section to transmit a control instruction to an image forming apparatus; and

a control section to allow the transmitting section to transmit an instruction to the image forming apparatus to switch to a low-power mode with less electric power consumption than a normal electric power mode or a power-off mode, when the electric power value is a predetermined standard switching value or higher.

It is desirable that the control section allows the transmitting section to transmit an instruction to the image forming apparatus to switch to the normal electric power mode, when the electric power value is a predetermined standard returning value or lower, while the image forming apparatus is in the low-power mode or the power-off mode.

It is desirable that the standard switching value is higher than the standard returning value.

A power source management apparatus reflecting another aspect of the present invention comprises:

a receiving section to receive information about an outdoor temperature;

a transmitting section to transmit a control instruction to an image forming apparatus; and

a control section to allow the transmitting section to transmit an instruction to the image forming apparatus to switch to a low-power mode with less electric power consumption than a normal electric power mode or a power-off mode, when the temperature is at a predetermined standard switching value or higher.

It is desirable that the control section allows the transmitting section to transmit an instruction to the image forming apparatus to switch to the normal electric power mode, when the temperature is at a predetermined standard returning value or lower, while the image forming apparatus is in the low-power mode or the power-off mode.

It is desirable that the standard switching value is higher than the standard returning value.

A power source management apparatus reflecting another aspect of the present invention comprises:

a receiving section to receive information about an outdoor humidity;

a transmitting section for transmitting a control instruction to an image forming apparatus; and

a control section to allow the transmitting section to transmit an instruction to the image forming apparatus to switch to a low-power mode with less electric power consumption than a normal electric power mode or a power-off mode, when the humidity is at a predetermined standard switching value or higher.

It is desirable that the control section allows the transmitting section to transmit an instruction to the image forming apparatus to switch to the normal electric power mode, when the humidity is at a predetermined standard returning value or lower, while the image forming apparatus is in the low-power mode or the power-off mode.

It is desirable that the standard switching value is higher than the standard returning value.

A power source management apparatus reflecting another aspect of the present invention comprises:

a receiving section to receive information about at least one of a forecast maximum temperature and a forecast minimum temperature of a day;

a transmitting section to transmit a control instruction to an image forming apparatus; and

a control section to allow the transmitting section to transmit an instruction to the image forming apparatus to switch to a low-power mode with less electric power consumption than a normal electric power mode or a power-off mode, when the at least one of the forecast maximum temperature and the forecast minimum temperature is at a predetermined standard switching value or higher.

It is desirable that the control section allows the transmitting section to transmit an instruction to the image forming apparatus to switch to the low-power mode or the power-off mode at a predetermined start time and allows the transmitting section to transmit an instruction to the image forming apparatus to switch to the normal electric power mode at a predetermined end time, when the at least one of the forecast maximum temperature and the forecast minimum temperature is at the predetermined standard switching value or higher.

A power source management apparatus reflecting another aspect of the present invention comprises:

a receiving section to receive information about a forecast temperature variation in a day;

a transmitting section to transmit a control instruction to an image forming apparatus; and

a control section to allow the transmitting section to transmit an instruction to the image forming apparatus to switch to a low-power mode with less electric power consumption than a normal electric power mode or a power-off mode, at a time when an ambient temperature is forecast to be at a predetermined standard switching value or higher, and to allow the transmitting section to transmit an instruction to the image forming apparatus to switch to a normal electric power mode at a time when the ambient temperature is forecast to be at a predetermined standard returning value or lower, based on the information about the forecast temperature variation.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 shows an example of a system configuration according to a first embodiment;

FIG. 2 is a block diagram showing a configuration of an image forming apparatus 10a;

FIG. 3 is a block diagram showing a configuration of a power source management apparatus 20;

FIG. 4 is a ladder chart showing electric power mode switching processing based on an electric power value according to the first embodiment;

FIG. 5 is a ladder chart showing processing of switching an electric power mode based on temperature and humidity according to a second embodiment;

FIG. 6 is a ladder chart showing processing of switching an electric power mode based on forecast maximum temperature according to a third embodiment;

FIG. 7 is a diagram for explaining a method of determining a time G1 for starting the low-power mode and a time G2 for ending the low-power mode based on forecast temperature variation information;

FIG. 8 is a ladder chart showing processing of switching an electric power mode based on forecast temperature variation according to a fourth embodiment; and

FIG. 9 shows a modification of a system comprising the power source management apparatus 20.

### DETAILED DESCRIPTION OF PREFERRED EMBODIMENTS

### First Embodiment

A first embodiment of the present invention is described.

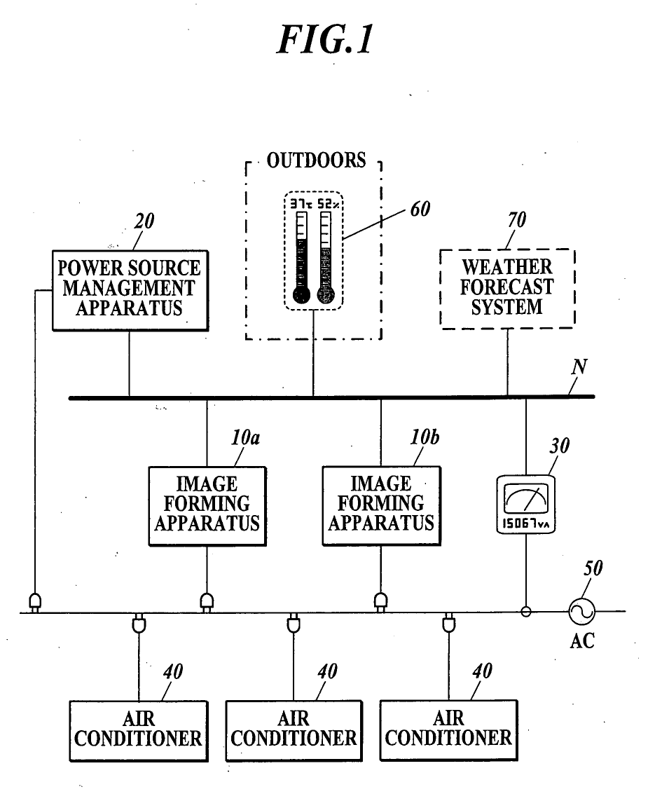

FIG. 1 shows an example of a system according to the first embodiment of the present invention. As shown in FIG. 1, image forming apparatuses 10a and 10b, a power source management apparatus 20, and an electric power meter 30 are connected through an ETHERNET® N so that communication is possible. Electric power is supplied from a power source 50 to the image forming apparatuses 10a and 10b, the power source management apparatus 20, and air conditioners 40. The image forming apparatuses 10a and 10b can be switched between a normal electric power mode (hereinafter referred to as the normal mode) and a low-power mode where electric power consumption is smaller than the normal mode. A thermohygrometer 60 and a weather forecast system 70 shown in FIG. 1 are not used in the first embodiment.

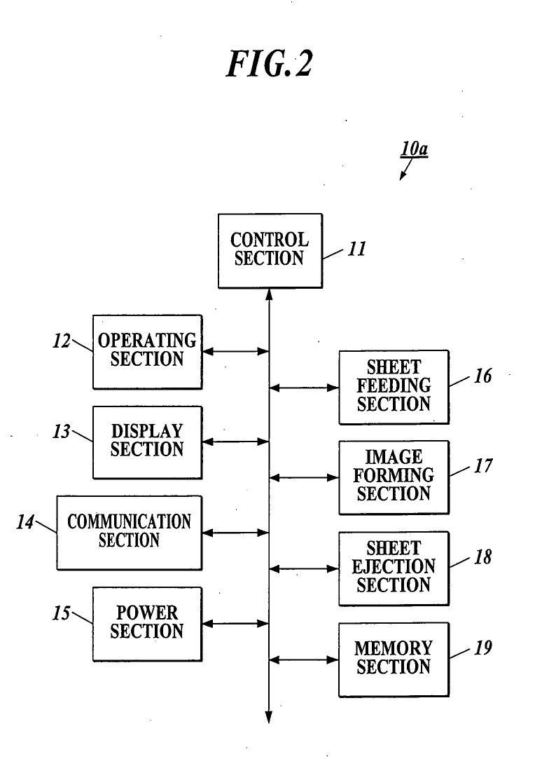

FIG. 2 illustrates a configuration of the image forming apparatus 10a. As shown in FIG. 2, the image forming apparatus 10a comprises a control section 11, an operating section 12, a display section 13, a communication section 14, a power section 15, a sheet feeding section 16, an image forming section 17, a sheet ejection section 18, and a memory section 19.

The control section 11 is composed of a CPU (Central Processing Unit), a ROM (Read Only Memory), a RAM (Random Access Memory), etc., and integrally controls the processing and operation of each section of the image forming apparatus 10a. Specifically, according to an operation signal input from the operating section 12 or an instruction signal received by the communication section 14, the CPU reads various processing programs stored in the ROM and develops the programs in the RAM to perform various processing in coordination with the programs.

When the control section 11 receives an instruction to switch to the low-power mode from the power source management apparatus 20 through the communication section 14, the control section 11 switches each section of the image forming apparatus 10a to the low-power mode. As a switch to the low-power mode, for example, the control section 11 changes the temperature of the fuser in the image forming section 17 to a lower temperature. Thereafter, when the control section 11 receives an instruction to switch to the normal mode from the power source management apparatus 20 through the communication section 14, the control section 11 switches each section of the image forming apparatus 10a to the normal mode.

The operating section 12 includes various keys such as a numeric key, a start key, a reset key, etc. and outputs a signal of the key held down to the control section 11. The operating section 12 also includes a touch panel formed in an integrated manner with the display section 13, and detects the location touched by a user's fingertip or a touch pen, etc. to output the signal of the location to the control section 11.

The display section 13 is composed of a LCD (Liquid Crystal Display), etc., and the touch panel is lapped over it. The display section 13 displays various screens based on display data input from the control section 11.

The communication section 14 is an interface for data communication by connecting to the ETHERNET N to communicate with an external apparatus such as the power source management apparatus 20, etc. Here, an example of the communication through the ETHERNET N is described. However the method of the communication is not limited.

The power section 15 includes a power plug, etc., and supplies electric power from the power source 50 to each section of the image forming apparatus 10a.

The sheet feeding section 16 feeds printing paper specified by the user among various types and sizes of printing paper to the image forming section 17, according to an instruction from the control section 11.

The image forming section 17 is a functional section including the components to form an image using imaging processing, such as electrophotography, electrostatic recording, thermal transfer, etc. For example, the image forming section 17 includes a photoreceptor, a transfer belt, a fuser, various carrier belts, an electronic circuit, a scanner, etc. According to an instruction from the control section 11, the image forming section 17 forms an image on the printing paper based on image information read by the scanner or image information received by the communication section 14 and carries it to the sheet ejection section 18.

The sheet ejection section 18 includes a sheet ejection tray, and ejects the printing paper carried from the image forming section 17 on the sheet ejection tray, according to an instruction from the control section 11.

The memory section 19 is composed of a nonvolatile memory, etc., and stores image information read by the scanner, image information received externally through the communication section 14 and the like.

The image forming apparatus 10b has a similar configuration to the image forming apparatus 10a, and thus illustrations and descriptions of the configuration thereof are omitted.

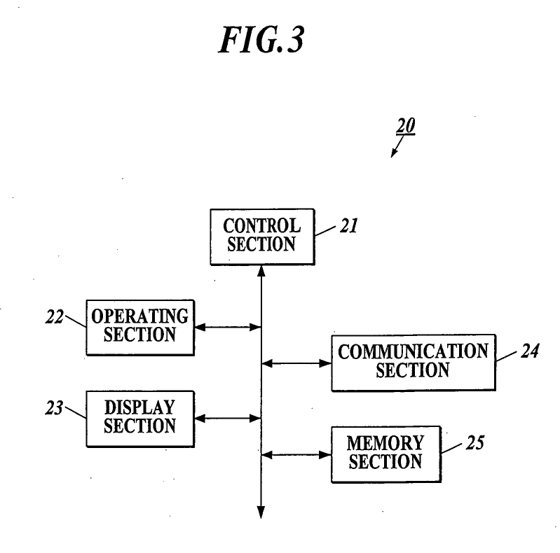

FIG. 3 shows the configuration of the power source management apparatus 20. As shown in FIG. 3, the power source management apparatus 20 comprises a control section 21, an operating section 22, a display section 23, a communication section 24, and a memory section 25.

The control section 21 is composed of a CPU, a ROM, a RAM, etc., and integrally controls the processing and operation of each section of the power source management apparatus 20. Specifically, the CPU reads various processing programs stored in the ROM and develops the programs in the RAM to perform various processing in coordination with the programs.

The operating section 22 includes a keyboard with a cursor key, a numeric key, an alphabetic key, etc. and a mouse, and outputs a signal of the key held down or the location signal of the mouse, etc. to the control section 21.

The display section 23 is composed of a LCD, etc., and displays various screens based on display data input from the control section 21.

The communication section 24 is an interface for data communication by connecting to the ETHERNET N to communicate with an external apparatus such as the image forming apparatuses 10a and 10b, the electric power meter 30, etc. Specifically, the communication section 24 receives information about an electric power value (hereinafter referred to as electric power value information) from the electric power meter 30 connected through the ETHERNET N. The communication section 24 transmits to the image forming apparatuses 10a and 10b a control instruction such as, an instruction to switch from the normal mode to the low-power mode, an instruction to switch from the low-power mode to the normal mode, etc.

The memory section 25 is composed of a storage medium and the like, such as a CD-ROM, a memory card, a hard disk, etc. and stores data used in various processing executed within the power source management apparatus 20, etc. Specifically, the memory section 25 stores a standard value A1 for switching to the low-power mode and a standard value A2 for returning to the normal mode, which are predetermined by a user. The standard value A1 for switching to the low-power mode is a minimum electric power value of the condition that allows the image forming apparatuses 10a and 10b to switch from the normal mode to the low-power mode, and the standard value A2 for returning to the normal mode is a maximum electric power value of the condition that allows the image forming apparatuses 10a and 10b to switch from the low-power mode to the normal mode. Here, the standard value A1 for switching to the low-power mode is to be larger than the standard value A2 for returning to the normal mode.

The control section 21 allows the communication section 24 to receive the electric power value information from the electric power meter 30, and when the electric power value at the electric power meter 30 is the standard value A1 for switching to the low-power mode or higher, allows the communication section 24 to transmit an instruction to switch to the low-power mode to the image forming apparatuses 10a and 10b. Alternatively, while the image forming apparatuses 10a and 10b are in the low-power mode, the control section 21 allows the communication section 24 to receive the electric power value information from the electric power meter 30, and when the electric power value of the electric power meter is the standard value A2 for returning to the normal mode or lower, the control section 21 allows the communication section 24 to transmit an instruction to switch to the normal mode to the image forming apparatuses 10a and 10b.

The electric power meter 30 shown in FIG. 1 measures the electric power value consumed in a predetermined area. The predetermined area includes the image forming apparatuses 10a and 10b, and may be a certain area where electric power is supplied by a shared power source 50 or may be an entire office of a business establishment, etc. The measuring object of the electric power meter 30 includes the image forming apparatuses 10a and 10b, the power source management apparatus 20, and other electronic goods (for example, the air conditioners 40, a florescent lamp, an elevator, etc.). The method of measuring the electric power value is not limited.

The air conditioners 40 are supplied with electric power from the power source 50 to adjust the temperature, humidity, etc. of the air indoors.

Next, the operation is described.

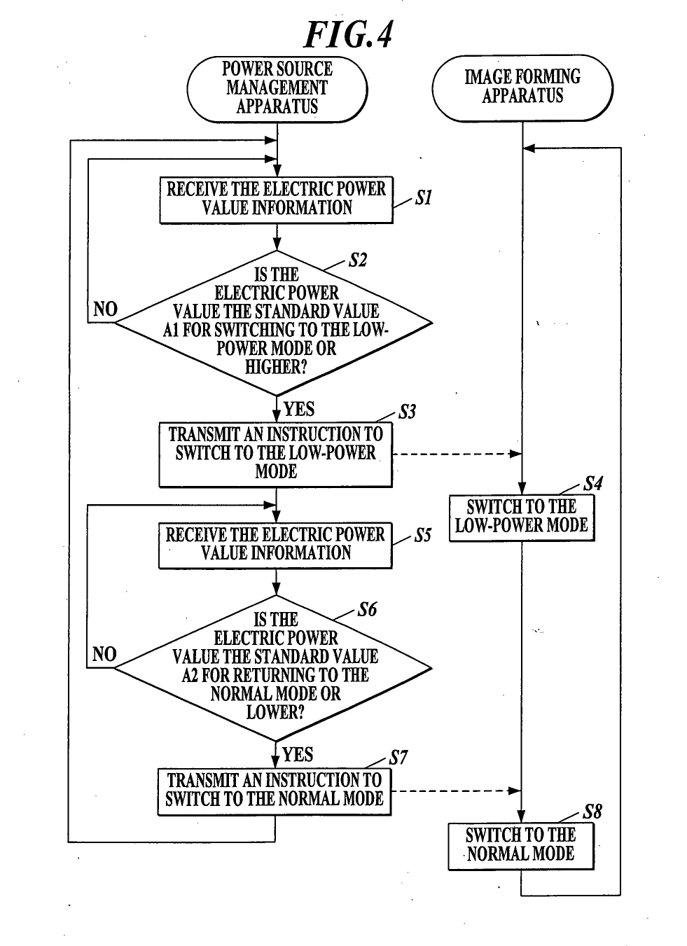

FIG. 4 is a ladder chart showing processing of switching the electric power mode executed in the power source management apparatus 20 and the image forming apparatus 10a based on the electric power value. The processing executed in the power source management apparatus 20 is implemented by a software processing of the CPU in the control section 21 in coordination with the program stored in the ROM in the control section 21, and the processing executed in the image forming apparatus 10a is implemented by a software processing of the CPU in the control section 11 in coordination with the program stored in the ROM in the control section 11.

As shown in FIG. 4, in the power source management apparatus 20, the communication section 24 accesses to the electric power meter 30 connected through the ETHERNET N, to receive the electric power value information from the electric power meter 30 (step S1). Then, the control section 21 determines whether the electric power value of the electric power meter 30 is the standard value A1 for switching to the low-power mode or higher, based on the electric power value information received from the electric power meter 30 (step S2). When the electric power value of the electric power meter 30 is lower than the standard value A1 for switching to the low-power mode (step S2; No), access to the electric power meter 30 is executed again by the communication section 24 after a certain time interval to receive the electric power value information (step S1). As long as the electric power value of the electric power meter 30 is lower than the standard value A1 for switching to the low-power mode, the processing of steps S1-S2 is repeated.

In step S2, when the electric power value of the electric power meter 30 is the standard value A1 for switching to the low-power mode or higher (step S2; Yes), the communication section 24 transmits an instruction to switch to the low-power mode to the image forming apparatus 10a (step S3).

In the image forming apparatus 10a, when the communication section 14 receives the instruction to switch to the low-power mode, the control section 11 switches each section of the image forming apparatus 10a to the low-power mode (step S4).

Next, while the image forming apparatus 10a is in the low-power mode, in the power source management apparatus 20, the communication section 24 accesses to the electric power meter 30 to receive the electric power value information from the electric power meter 30 (step S5). Then, the control section 21 determines whether the electric power value is the standard value A2 for returning to the normal mode or lower, based on the electric power value information received from the electric power meter 30 (step S6). When the electric power value of the electric power meter 30 is higher than the standard value A2 for returning to the normal mode (step S6; No), the communication section 24 accesses to the electric power meter 30 again after a certain time interval to receive the electric power value information (step S5). As long as the electric power value of the electric power meter 30 is higher than the standard value A2 for returning to the normal mode, the processing of steps S5-S6 is repeated.

In step S6, if the electric power value of the electric power meter 30 is the standard value A2 for returning to the normal mode or lower (step S6; Yes), the communication section 24 transmits an instruction to switch to the normal mode to the image forming apparatus 10a (step S7).

In the image forming apparatus 10a, when the communication section 14 receives the instruction to switch to the normal mode, the control section 11 switches each section of the image forming apparatus 10a to the normal mode (step S8).

After step S8, the processing of steps S1-S8 is repeated in the power source management apparatus 20 and the image forming apparatus 10a.

The processing for switching the electric power mode executed in the power source management apparatus 20 and the image forming apparatus 10b based on the electric power value is similar to the above, thus the description is omitted.

As described above, according to the power source management apparatus 20 of the first embodiment, when the electric power value of the electric power meter 30 is the standard value A1 for switching to the low-power mode or higher, an instruction to switch to the low-power mode is transmitted to the image forming apparatuses 10a and 10b. Consequently, the electric power consumption in the image forming apparatuses 10a and 10b can be reduced to prevent electric power shortage. Also, when the electric power value of the electric power meter 30 is the standard value A2 for returning to the normal mode or lower, an instruction to switch to the normal mode is sent to the image forming apparatuses 10a and lob. Consequently, when the possibility of electric power shortage is small, the apparatuses can be returned to the normal mode.

Since the standard value A1 for switching to the low-power mode is set to higher than the standard value A2 for returning to the normal mode, once after the electric power value of the electric power meter 30 becomes the standard value A1 for switching to the low-power mode or higher and the image forming apparatuses 10a and 10b switch to the low-power mode, the low-power mode is maintained until the electric power value of the electric power meter 30 becomes the standard value A2 for returning to the normal mode or lower. Consequently the stability of the electric power status of the image forming apparatuses 10a and 10b can be improved.

Since the power source management apparatus 20 allows a plurality of image forming apparatuses 10a and 10b to be managed centrally and integrally, a user can be saved from a trouble of managing the electric power consumption of respective image forming apparatuses 10a and lob.

Further, in the first embodiment, the image forming apparatuses 10a and 10b switch to the low-power mode when the electric power value measured by the electric power meter 30 is the standard value A1 for switching to the low-power mode or higher. Alternatively, the image forming apparatuses 10a and 10b may be switched to a power-off mode when the electric power value measured by the electric power meter 30 is a predetermined electric power value or higher. The power-off mode is a status of the image forming apparatuses 10a and 10b where the operation of the power section 15 is stopped and the electric power supply from the power source 50 to each section of the image forming apparatuses 10a and 10b is cut off.

In the first embodiment, the power source management apparatus 20 receives the electric power value information from the electric power meter 30. However the information of consumed electric power value in a certain area may be provided by an electric power supply company.

In the first embodiment, the standard value A1 for switching to the low-power mode is higher than the standard value A2 for returning to the normal mode. However the standard value A1 for switching to the low-power mode may be the same as the standard value A2 for returning to the normal mode.

### Second Embodiment

Next, a second embodiment of the present invention is described.

As the second embodiment employs a thermohygrometer 60 instead of the electric power meter 30 shown in FIG. 1 of the first embodiment, the second embodiment is described using FIG. 1. The other configurations are similar to the first embodiment, thus the same reference numerals are applied to the same components, and the descriptions thereof are omitted. The characteristic configurations and processing of the second embodiment are described below.

The thermohygrometer 60 includes a thermometer for measuring temperature and a hygrometer for measuring humidity and is placed outdoors, etc. where it is difficult to be influenced by air conditioners 40. Image forming apparatuses 10a and 10b, a power source management apparatus 20, and the thermohygrometer 60 are connected through an ETHERNET N so that communication is possible.

A communication section 24 of the power source management apparatus 20 receives information about the temperature (hereinafter referred to as temperature information) and information about the humidity (hereinafter referred to as humidity information) from the thermohygrometer 60 connected through the ETHERNET N.

A memory section 25 stores a standard value B1 for switching to the low-power mode, a standard value B2 for returning to the normal mode, a standard value C1 for switching to the low-power mode, and a standard value C2 for returning to the normal mode, which are predetermined by a user. The standard value B1 for switching to the low-power mode is a minimum temperature of the condition that allows the image forming apparatuses 10a and 10b to switch from the normal mode to the low-power mode. The standard value B2 for returning to the normal mode is a maximum temperature of the condition that allows the image forming apparatuses 10a and 10b to switch from the low-power mode to the normal mode. The standard value C1 for switching to the low-power mode is a minimum humidity of the condition that allows the image forming apparatuses 10a and 10b to switch from the normal mode to the low-power mode. The standard value C2 for returning to the normal mode is a maximum humidity of the condition that allows the image forming apparatuses 10a and 10b to switch from the low-power mode to the normal mode. Here, the standard value B1 for switching to the low-power mode is larger than the standard value B2 for returning to the normal mode, and the standard value C1 for switching to the low-power mode is larger than the standard value C2 for returning to the normal mode.

A control section 21 allows the communication section 24 to receive the temperature information and the humidity information from the thermohygrometer 60, and when the temperature of the thermohygrometer 60 is at the standard value B1 for switching to the low-power mode or higher and the humidity is at the standard value C1 for switching to the low-power mode or higher allows the communication section 24 to transmit an instruction to switch to the low-power mode to the image forming apparatuses 10a and lob. Alternatively, while the image forming apparatuses 10a and 10b are in the low-power mode, the control section 21 allows the communication section 24 to receive the temperature information and the humidity information from the thermohygrometer 60, and when the temperature of the thermohygrometer 60 is at the standard value B2 for returning to the normal mode or lower and the humidity is at the standard value C2 for returning to the normal mode or lower, the control section 21 allows the communication section 24 to transmit an instruction to switch to the normal mode to the image forming apparatuses 10a and 10b.

Next, the operation is described.

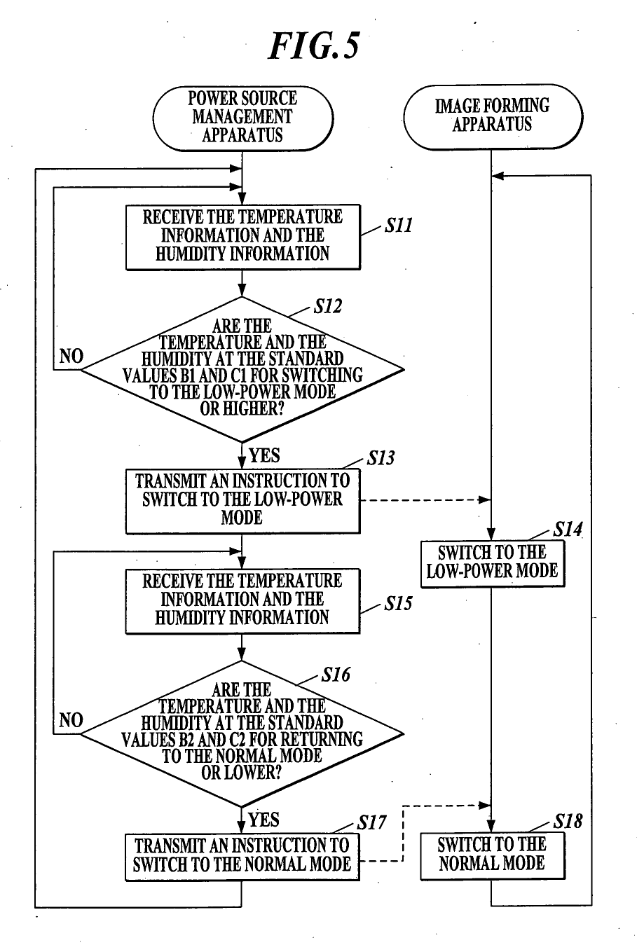

FIG. 5 is a ladder chart showing processing of switching the electric power mode executed in the power source management apparatus 20 and the image forming apparatus 10a based on the temperature and the humidity.

As shown in FIG. 5, in the power source management apparatus 20, the communication section 24 accesses to the thermohygrometer 60 connected through the ETHERNET N to receive the temperature information and the humidity information from the thermohygrometer 60 (step S11). Then, the control section 21 determines whether the temperature is at the standard value B1 for switching to the low-power mode or higher, and whether the humidity is at the standard value C1 for switching to the low-power mode or higher, based on the temperature information and the humidity information received from the thermohygrometer 60 (step S12). When the temperature is lower than the standard value B1 for switching to the low-power mode or when the humidity is lower than the standard value C1 for switching to the low-power mode (step S12; No), the communication section 24 accesses to the thermohygrometer 60 again after a certain time interval to receive the temperature information and the humidity information (step S11). As long as the temperature is lower than the standard value B1 for switching to the low-power mode or the humidity is lower than the standard value C1 for switching to the low-power mode, the processing of steps S11-S12 is repeated.

In step S12, when the temperature is at the standard value B1 for switching to the low-power mode or higher and the humidity is at the standard value C1 for switching to the low-power mode or higher (step S12; Yes), the communication section 24 transmits an instruction to switch to the low-power mode to the image forming apparatus 10a (step S13).

When the image forming apparatus 10a receives the instruction to switch to the low-power mode by a communication section 14, a control section 11 switches each section of the image forming apparatus 10a to the low-power mode (step S14).

Next, while the image forming apparatus 10a is in the low-power mode, in the power source management apparatus 20, the communication section 24 accesses to the thermohygrometer 60 to receive the temperature information and the humidity information from the thermohygrometer 60 (step S15). Then, the control section 21 determines whether the temperature is at the standard value B2 for returning to the normal mode or lower and whether the humidity is at the standard value C2 for returning to the normal mode or lower, based on the temperature information and the humidity information received from the thermohygrometer 60 (step S16). When the temperature is higher than the standard value B2 for returning to the normal mode or when the humidity is higher than the standard value C2 for returning to the normal mode (step S16; No), the communication section 24 accesses to the thermohygrometer 60 again after a certain time interval to receive the temperature information and the humidity information (step S15). As long as the temperature is higher than the standard value B2 for returning to the normal mode or the humidity is higher than the standard value C2 for returning to the normal mode, the processing of steps S15-S16 is repeated.

In step S16, when the temperature is at the standard value B2 for returning to the normal mode or lower and the humidity is at the standard value C2 for returning to the normal mode or lower, (step S16; Yes), the communication section 24 transmits an instruction to switch to the normal mode to the image forming apparatus 10a (step S17).

When the image forming apparatus 10a receives the instruction to switch to the normal mode from the communication section 14, the control section 11 switches each section of the image forming apparatus 10a to the normal mode (step S18).

After step S18, the processing of steps S11-S18 is repeated in the power source management apparatus 20 and the image forming apparatus 10a.

The processing for switching the electric power mode executed in the power source management apparatus 20 and the image forming apparatus 10b based on the temperature and the humidity is similar to the above, thus the description thereof is omitted.

As described above, according to the power source management apparatus 20 of the second embodiment, when the temperature is at the standard value B1 for switching to the low-power mode or higher and the humidity is at the standard value C1 for switching to the low-power mode or higher, the instruction to switch to the low-power mode is transmitted to the image forming apparatuses 10a and lob, so that in an environment of high temperature and high humidity, such as during daytime in summer, etc., when the electric power consumption increases due to the use of air conditioners 40, etc. Consequently, the electric power consumption of the image forming apparatuses 10a and 10b can be reduced to prevent electric power shortage. When the temperature is at the standard value B2 for returning to the normal mode or lower and the humidity is at the standard value C2 for returning to the normal mode or lower, an instruction to switch to the normal mode is transmitted to the image forming apparatuses 10a and 10b. Consequently, when the possibility of electric power shortage is small, the apparatuses can be returned to the normal mode.

Since the standard value B1 for switching to the low-power mode is set to higher than the standard value B2 for returning to the normal mode and the standard value C1 for switching to the low-power mode is set to higher than the standard value C2 for returning to the normal mode, once after the temperature becomes the standard value B1 for switching to the low-power mode or higher and the humidity becomes the standard value C1 for switching to the low-power mode or higher and the image forming apparatuses 10a and 10b switch to the low-power mode, the low-power mode is maintained until the temperature becomes the standard value B2 for returning to the normal mode or lower and the humidity becomes the standard value C2 for returning to the normal mode or lower. Thus, the stability of the electric power situation of the image forming apparatuses 10a and 10b can be improved.

Further, in the second embodiment, the image forming apparatuses 10a and 10b switch to the low-power mode when the temperature of the thermohygrometer 60 becomes the standard value B1 for switching to the low-power mode or higher and the humidity of the thermohygrometer 60 becomes the standard value C1 for switching to the low-power mode or higher. Alternatively the image forming apparatuses 10a and 10b may be switched to a power-off mode when the temperature or humidity of the thermohygrometer 60 is at a predetermined value or higher.

In the second embodiment, the image forming apparatuses 10a and 10b switch to the low-power mode or the normal mode based on the temperature information and the humidity information received from the thermohygrometer 60. Alternatively, instead of the thermohygrometer 60, the image forming apparatuses 10a and 10b may be switched to the low-power mode or the normal mode based on the temperature information or the humidity information received from either one of a thermometer or a hygrometer. For example, in an area with high temperature and low humidity, a setting to switch to the low-power mode based on the humidity is not necessary. Thus, only the temperature may be the object.

### Third Embodiment

Next, a third embodiment according to the present invention is described.

As the third embodiment employs a weather forecast system 70 instead of an electric power meter 30 shown in FIG. 1 of the first embodiment, the third embodiment is described using FIG. 1. The other configurations are similar to the first embodiment, thus the same reference numerals are applied to the same components, and the descriptions thereof are omitted. The characteristic configurations and processing of the third embodiment are described below.

The weather forecast system 70 includes a memory unit to store information about a forecast maximum temperature, a forecast minimum temperature, forecast temperature variation, etc. in a day, and provides these information when an access is made from external apparatuses such as a power source management apparatus 20, etc. connected through the ETHERNET N. A typical weather forecast website which provides temperature and weather information can be used as the weather forecast system 70. Image forming apparatuses 10a and 10b, the power source management apparatus 20, and the weather forecast system 70 are connected to each other through the ETHERNET N so that communication is possible.

A communication section 24 of the power source management apparatus 20 receives information about the forecast maximum temperature in the day (hereinafter referred to as forecast maximum temperature information) from the weather forecast system 70 connected through the ETHERNET N.

A memory section 25 stores a standard value D1 for switching to the low-power mode, a time E1 for starting the low-power mode and a time E2 for ending the low-power mode, which are predetermined by a user. The standard value D1 for switching to the low-power mode is a minimum temperature of a condition that allows the image forming apparatuses 10a and 10b to switch from the normal mode to the low-power mode. Also, the time E1 for starting the low-power mode is a time when the image forming apparatuses 10a and 10b switch from the normal mode to the low-power mode, and the time E2 for ending the low-power mode is a time when the image forming apparatuses 10a and 10b switch from the low-power mode to the normal mode. The time E1 for starting the low-power mode and the time E2 for ending the low-power mode can be set freely. However, generally it is desirable that the times are set based on a time frame predicted to consume the most electric power.

A control section 21 allows the communication section 24 to receive the forecast maximum temperature information from the weather forecast system 70. When the forecast maximum temperature is at the standard value D1 for switching to the low-power mode or higher, the control section 21 allows the communication section 24 to transmit an instruction at the time E1 for starting the low-power mode to switch to the low-power mode to the image forming apparatuses 10a and 10b, and allows the communication section 24 to transmit an instruction at the time E2 for ending the low-power mode to switch to the normal mode to the image forming apparatuses 10a and 10b.

Next, the operation is described.

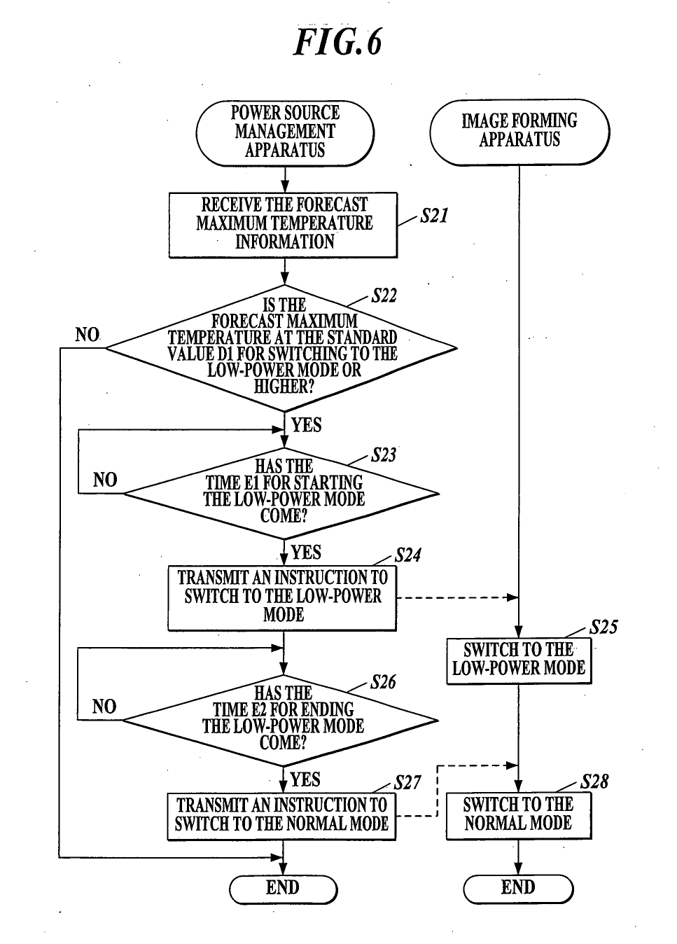

FIG. 6 is a ladder chart showing processing of switching the electric power mode executed in the power source management apparatus 20 and the image forming apparatus 10a based on the forecast maximum temperature. This processing starts at a predetermined time of a day.

As shown in FIG. 6, in the power source management apparatus 20, the communication section 24 accesses to the weather forecast system 70 connected through the ETHERNET N, to receive the forecast maximum temperature information in a day from the weather forecast system 70 (step S21). Then, the control section 21 determines whether the forecast maximum temperature is at the standard value D1 for switching to the low-power mode or higher, based on the forecast maximum temperature information received from the weather forecast system 70 (step S22). When the temperature is lower than the standard value D1 for switching to the low-power mode (step S22; No), the processing is terminated.

In step S22, when the forecast maximum temperature is at the standard value D1 for switching to the low-power mode or higher (step S22; Yes), the control section 21 determines whether the time E1 for starting the low-power mode has come (step S23). At the time E1 for starting the low-power mode (step S23; Yes), the communication section 24 transmits an instruction to switch to the low-power mode to the image forming apparatus 10a (step S24).

When the image forming apparatus 10a receives the instruction to switch to the low-power mode by a communication section 14, a control section 11 switches each section of the image forming apparatus 10a to the low-power mode (step S25).

Next, in the power source management apparatus 20, the control section 21 determines whether the time E2 for ending the low-power mode has come (step S26). At the time E2 for ending the low-power mode (step S26; Yes), the communication section 24 transmits an instruction to switch to the normal mode to the image forming apparatus 10a (step S27).

When the image forming apparatus 10a receives the instruction to switch to the normal mode by the communication section 14, the control section 11 switches each section of the image forming apparatus 10a to the normal mode (step S28).

That is the end of the processing of switching the electric power mode based on the forecast maximum temperature.

The processing for switching the electric power mode executed in the power source management apparatus 20 and the image forming apparatus 10b based on the forecast maximum temperature is similar to the above, thus the description is omitted.

As described above, according to the power source management apparatus 20 of the third embodiment, when the forecast maximum temperature is at the standard value D1 for switching to the low-power mode or higher, an instruction to switch to the low-power mode is transmitted at the time E1 for starting the low-power mode to the image forming apparatuses 10a and 10b, and an instruction to switch to the normal mode is transmitted at the time E2 for ending the low-power mode to the image forming apparatuses 10a and 10b. Consequently, the electric power consumption of the image forming apparatuses 10a and 10b can be reduced to prevent electric power shortage.

Further, in the third embodiment, the image forming apparatuses 10a and 10b switch to the low-power mode at the time E1 for starting the low-power mode when the forecast maximum temperature is at the standard value D1 for switching to the low-power mode or higher. Alternatively, the image forming apparatuses 10a and 10b may be switched to a power-off mode at a predetermined time when the forecast maximum temperature is at a predetermined temperature or higher.

In the third embodiment, the image forming apparatuses 10a and 10b switch to the low-power mode based on the forecast maximum temperature information received from the weather forecast system 70. Alternatively, the image forming apparatuses 10a and 10b may receive the forecast minimum temperature from the weather forecast system 70, and may be switched to the low-power mode or the power-off mode when the forecast minimum temperature is at a predetermined temperature or higher. Also, the information that the power source management apparatus 20 receives from the weather forecast system 70 is not limited to the information of the current day. It is possible to determine whether to switch the image forming apparatuses 10a and 10b to the low-power mode or the power-off mode on the next day, based on at least one of the forecast maximum temperature and the forecast minimum temperature of the next day.

### Fourth Embodiment

Next, a fourth embodiment of the present invention is described.

As the fourth embodiment employs a weather forecast system 70 instead of the electric power meter 30 shown in FIG. 1 of the first embodiment, the fourth embodiment is described using FIG. 1. The weather forecast system 70 employed is similar to the system employed in the third embodiment, thus the descriptions are omitted. The other configurations are similar to the first embodiment, thus the same reference numerals are applied to the same components, and the descriptions thereof are omitted. The characteristic configurations and processing of the fourth embodiment are described below.

A communication section 24 of a power source management apparatus 20 receives information about the forecast temperature variation (hereinafter referred to as forecast temperature variation information) in a day.

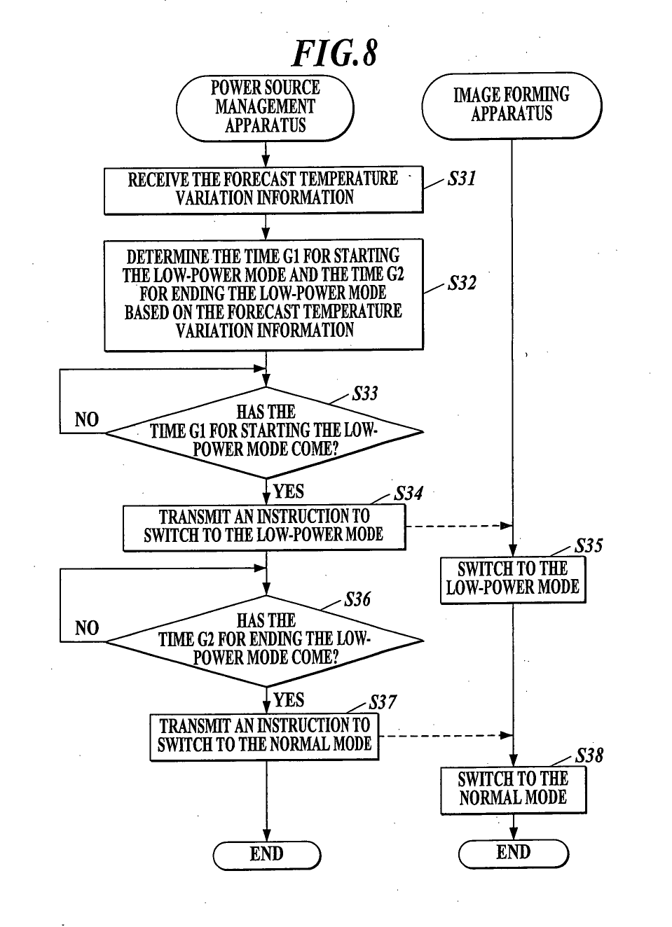

A memory section 25 stores a standard value F1 for switching to the low-power mode and a standard value F2 for returning to the normal mode, which are predetermined by a user. The standard value F1 for switching to the low-power mode is the minimum temperature of the condition that allows image forming apparatuses 10a and 10b to switch from the normal mode to the low-power mode. The standard value F2 for returning to the normal mode is the maximum temperature of the condition that allows the image forming apparatuses 10a and 10b to switch from the low-power mode to the normal mode. Here, the standard value F1 for switching to the low-power mode is larger than the standard value F2 for returning to the normal mode. Also, the memory section 25 stores a time G1 for starting the low-power mode and a time G2 for ending the low-power mode which are determined in the mode switching processing described below based on the forecast temperature variation (See FIG. 8).

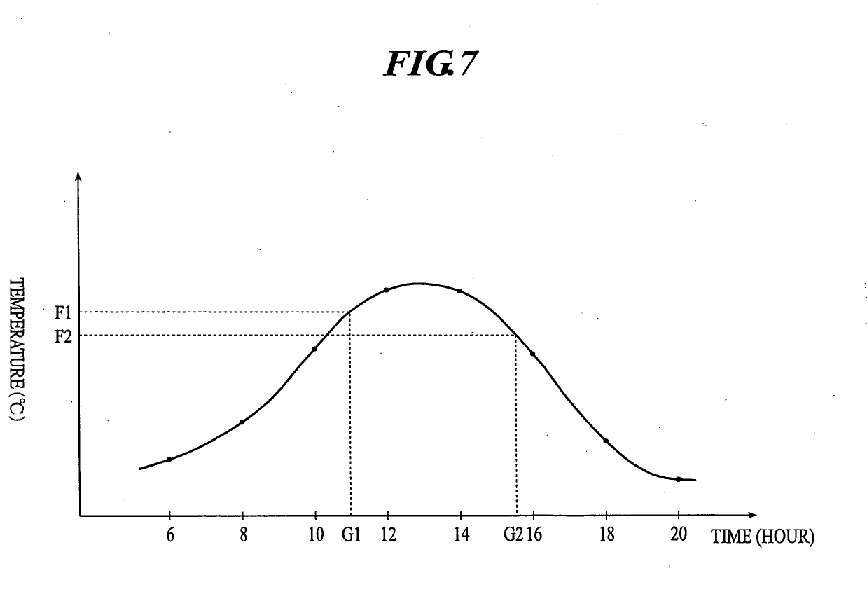

A control section 21 allows the communication section 24 to receive the forecast temperature variation information in a day from the weather forecast system 70. The forecast temperature variation information, as shown in FIG. 7, is forecast temperatures associated with times. FIG. 7 is an example where the weather forecast system 70 provides the information of every two hours as the forecast temperature variation information. As shown in FIG. 7, based on the forecast temperature variation information, the control section 21 determines the time when the temperature is forecast to be at the standard value F1 for switching to the low-power mode or higher, as the time G1 for starting the low-power mode, and determines the time when the temperature is forecast to be at the standard value F2 for returning to the normal mode or lower, as the time G2 for ending the low-power mode. If the time and forecast temperature in the forecast temperature variation information is discrete (for example, every one hour, every two hours, etc.) the time G1 for starting the low-power mode and the time G2 for ending the low-power mode may be determined by interpolating the surrounding data. The control section 21 allows the communication section 24 to transmit an instruction at the time G1 for starting the low-power mode to switch to the low-power mode to the image forming apparatuses 10a and 10b. The control section 21 allows the communication section 24 to transmit an instruction at the time G2 for ending the low-power mode to switch to the normal mode to the image forming apparatuses 10a and 10b.

Next, the operation is described.

FIG. 8 is a ladder chart showing processing of switching the electric power mode executed in the power source management apparatus 20 and the image forming apparatus 10a based on the forecast temperature variation. This processing starts at a predetermined time of a day.

As shown in FIG. 8, in the power source management apparatus 20, the communication section 24 accesses to the weather forecast system 70 connected through the ETHERNET N to receive the forecast temperature variation information from the weather forecast system 70 (step S31). Then, based on the forecast temperature variation information received from the weather forecast system 70, the control section 21 determines the time G1 for starting the low-power mode, which is the time when the temperature is forecast to be at the standard value F1 for switching to the low-power mode or higher, and determines the time G2 for ending the low-power mode, which is the time when the temperature is forecast to be at the standard value F2 for returning to the normal mode (step S32).

Next, the control section 21 determines whether the time G1 for starting the low-power mode has come (step S33). At the time G1 for starting the low-power mode (step S33; Yes), the communication section 24 transmits an instruction to switch to the low-power mode to the image forming apparatus 10a (step S34).

When the image forming apparatus 10a receives the instruction to switch to the low-power mode by a communication section 14, a control section 11 switches each section of the image forming apparatus 10a to the low-power mode (step S35).

Next, in the power source management apparatus 20, the control section 21 determines whether the time G2 for ending the low-power mode has come (step S36). At the time G2 for ending the low-power mode (step S36; Yes), the communication section 24 transmits an instruction to switch to the normal mode to the image forming apparatus 10a (step S37).

When the image forming apparatus 10a receives the instruction to switch to the normal mode by the communication section 14, the control section 11 switches each section of the image forming apparatus 10a to the normal mode (step S38).

That is the end of the processing of switching the electric power mode based on the forecast temperature variation.

The processing for switching the electric power mode executed in the power source management apparatus 20 and the image forming apparatus 10b based on the forecast temperature variation is similar to the above, thus the description is omitted.

As described above, according to the power source management apparatus 20 of the fourth embodiment, at the time G1 for starting the low-power mode, which is the time when the temperature is forecast to be at the standard value F1 for switching to the low-power mode or higher, an instruction to switch to the low-power mode is transmitted to the image forming apparatuses 10a and lob. Also, at the time G2 for ending the low-power mode, which is the time when the temperature is forecast to be at the standard value F2 for returning to the normal mode or lower, an instruction to switch to the normal mode is transmitted to the image forming apparatuses 10a and lob. Consequently, the electric power consumption in the image forming apparatuses 10a and 10b can be reduced, to prevent electric power shortage.

In the fourth embodiment, the image forming apparatuses switch to the low-power mode or the normal mode according to the time G1 for starting the low-power mode and the time G2 for ending the low-power mode determined based on the forecast temperature variation. Alternatively, a time for starting a power-off mode and ending the power-off mode may be determined based on the forecast temperature variation. Also, the image forming apparatuses 10a and 10b may be switched to the power-off mode or the normal mode according to the determined times.

The descriptions of each embodiment described above are to show examples of the power source management apparatus according to the present invention, and thus are not intended to limit the present invention. Detailed configurations and detailed operations of each section configuring the apparatus may be modified without departing from the scope of the present invention.

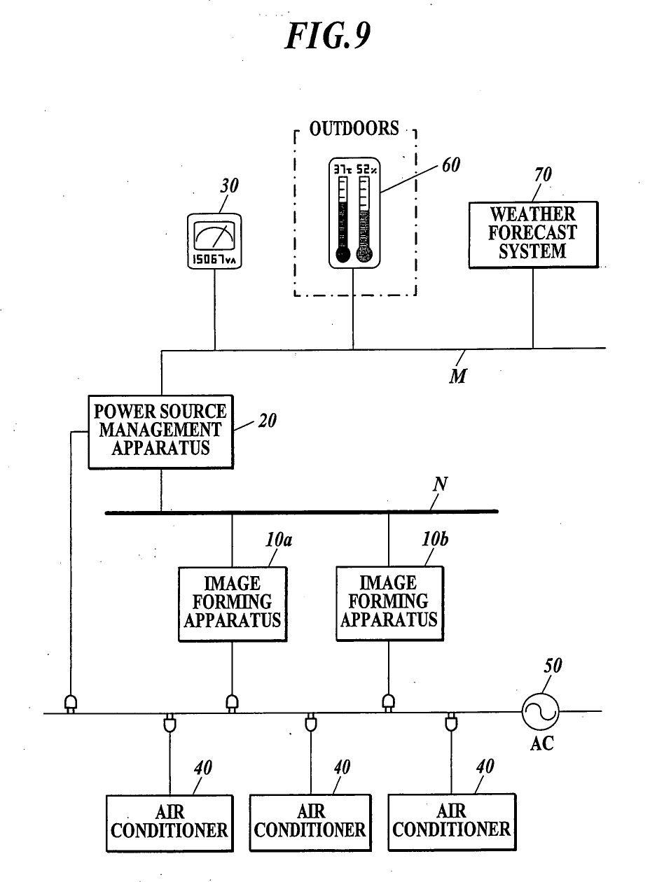

For example, the image forming apparatuses 10a and 10b may not be directly connected to the electric power meter 30, the thermohygrometer 60 or the weather forecast system 70, as shown in FIG. 9 where the image forming apparatuses 10a and 10b are connected to the power source management apparatus 20 through the ETHERNET N, and further, the power source management apparatus 20 is connected to the electric power meter 30, the thermohygrometer 60, and the weather forecast system 70 with a dedicated communication line M, etc. In this case, the power source management apparatus 20 receives the electric power value information from the power meter 30, the temperature information and the humidity information from the thermohygrometer 60, and the forecast maximum temperature information and the forecast temperature variation information from the weather forecast system 70, etc., through the dedicated communication line M.

FIG. 1 and FIG. 9 illustrate the case where there are two image forming apparatuses, but the number of the image forming apparatuses managed by the power source management apparatus 20 may be one or may be three or more. Alternatively, the power source management apparatus 20 may manage the electric power consumption of only a certain apparatus among the plurality of image forming apparatuses that are objects of management.

In the above embodiments, the objects controlled by the power source management apparatus 20 are image forming apparatuses 10a and 10b have been described. However, the power source management apparatus 20 may manage the electric power consumption of an electric apparatus other than an image forming apparatus.

Instead of the power source management apparatus 20 being provided separately, the control section 11 within the image forming apparatuses 10a and 10b may have the function of managing the electric power consumption of the image forming apparatus, the function as shown from the first embodiment to the fourth embodiment.

What is claimed is:

1. A power source management apparatus comprising:
a receiving section to receive information about consumed electric power value in a predetermined area;
a transmitting section to transmit a control instruction to an image forming apparatus; and
a control section to allow the transmitting section to transmit an instruction to the image forming apparatus to switch to a low-power mode with less electric power consumption than a normal electric power mode or a power-off mode, when the electric power value is a predetermined standard switching value or higher.

2. The power source management apparatus of claim 1, wherein the control section allows the transmitting section to transmit an instruction to the image forming apparatus to switch to the normal electric power mode, when the electric power value is a predetermined standard returning value or lower, while the image forming apparatus is in the low-power mode or the power-off mode.

3. The power source management apparatus of claim 2, wherein the standard switching value is higher than the standard returning value.

4. A power source management apparatus comprising:
a receiving section to receive information about an outdoor temperature;
a transmitting section to transmit a control instruction to an image forming apparatus; and
a control section to allow the transmitting section to transmit an instruction to the image forming apparatus to switch to a low-power mode with less electric power consumption than a normal electric power mode or a power-off mode, when the temperature is at a predetermined standard switching value or higher.

5. The power source management apparatus of claim 4, wherein the control section allows the transmitting section to transmit an instruction to the image forming apparatus to switch to the normal electric power mode, when the temperature is at a predetermined standard returning value or lower, while the image forming apparatus is in the low-power mode or the power-off mode.

6. The power source management apparatus of claim 5, wherein the standard switching value is higher than the standard returning value.

7. A power source management apparatus comprising:
a receiving section to receive information about an outdoor humidity;
a transmitting section to transmit a control instruction to an image forming apparatus; and
a control section to allow the transmitting section to transmit an instruction to the image forming apparatus to switch to a low-power mode with less electric power consumption than a normal electric power mode or a power-off mode, when the humidity is at a predetermined standard switching value or higher.

8. The power source management apparatus of claim 7, wherein the control section allows the transmitting section to transmit an instruction to the image forming apparatus to switch to the normal electric power mode, when the humidity is at a predetermined standard returning value or lower, while the image forming apparatus is in the low-power mode or the power-off mode.

9. The power source management apparatus of claim 8, wherein the standard switching value is higher than the standard returning value.

10. A power source management apparatus comprising:
a receiving section to receive information about at least one of a forecast maximum temperature and a forecast minimum temperature of a day;
a transmitting section to transmit a control instruction to an image forming apparatus; and
a control section to allow the transmitting section to transmit an instruction to the image forming apparatus to switch to a low-power mode with less electric power consumption than a normal electric power mode or a power-off mode, when the at least one of the forecast maximum temperature and the forecast minimum temperature is at a predetermined standard switching value or higher.

11. The power source management apparatus of claim 10, wherein the control section allows the transmitting section to transmit an instruction to the image forming apparatus to switch to the low-power mode or the power-off mode at a predetermined start time and allows the transmitting section to transmit an instruction to the image forming apparatus to switch to the normal electric power mode at a predetermined end time, when the at least one of the forecast maximum temperature and the forecast minimum temperature is at the predetermined standard switching value or higher.

12. A power source management apparatus comprising:
a receiving section to receive information about a forecast temperature variation in a day;
a transmitting section to transmit a control instruction to an image forming apparatus; and
a control section to allow the transmitting section to transmit an instruction to the image forming apparatus to switch to a low-power mode with less electric power consumption than a normal electric power mode or a power-off mode, at a time when an ambient temperature is forecast to be at a predetermined standard switching value or higher, and to allow the transmitting section to transmit an instruction to the image forming apparatus to switch to a normal electric power mode at a time when the ambient temperature is forecast to be at a predetermined standard returning value or lower, based on the information about the forecast temperature variation.
